(19) United States
(12) Patent Application Publication
(10) Pub. No.: US 2018/0141826 A1
(43) Pub. Date: May 24, 2018

(54) WATER DESALINATION SYSTEM AND METHOD FOR FAST COOLING SALINE WATER USING FAST FREEZE PROCESS

(71) Applicant: General Electric Company, Schenectady, NY (US)

(72) Inventors: Vitali Victor Lissianski, Schenectady, NY (US); KImberly Nicole Hammer, Niskayuna, NY (US)

(21) Appl. No.: 15/360,993

(22) Filed: Nov. 23, 2016

(51) Int. Cl. C02F 1/22; B01D 9/00

(52) U.S. Cl. CPC C02F 1/22; C02F 2103/08; B01D 9/0009

(57) ABSTRACT

A desalinating system and process is disclosed. The desalination system comprises using a freeze or fast-cooling process to freeze saline water droplets in a controlled manner that provides for diffusion of salt ions to a center of each frozen saline water droplet and formation of salt crystals surrounded by pure water crystals. The pure water crystals and salt crystals are subsequently separated in an ice melter using heat exchange to form a pure water stream.

### STATEMENT ON FEDERALLY SPONSORED RESEARCH OR DEVELOPMENT

This invention was made with government support under grant number DE-FE0024022 awarded by the U.S. Department of Energy. The government has certain rights in the invention.

### BACKGROUND

The present application relates generally to the field of desalination of liquids. Embodiment of the disclosure relate to a desalination system and method.

Fresh water shortage affects roughly one-third of the world's population and is becoming more critical in recent years due to drought, population increase, development of population centers in arid areas, and pollution. About 97.5% of the water on earth is saltwater and the remaining about 2.5% is fresh water. Therefore, a practical, economically viable desalination process is crucial to overcoming this crisis. For these reasons, and others, desalination is an important issue.

Desalination can be accomplished by a number of methods known in the art. Conventionally, the most commonly used desalination process involves variations of one or more thermal processes, for example evaporation. Although these thermal methods involve a high energy requirement, energy integration and recovery make them reasonable efficient for low salinity solutions. Energy requirements for thermal methods increase significantly as solution salinity increases. Other known desalination methods include membrane processes, e.g. filtration methods such as reverse osmosis (RO). Although membrane performance gradually has improved, membrane technology are typically used for low salinity brines such as brackish water are sea water. Treatment of high salinity brines remains high energy demand process making it economically challenging.

Freeze crystallization is a thermal desalination process wherein saline water is chilled to a temperature sufficient for the saline water to freeze. It is based on the fundamental principle that the structure of an individual ice crystal does not accommodate salts. As a result, ice crystals, formed after water in brine freezes and is separated from the resulting salt crystals, consist of pure water. These pure ice crystals can then be separated from the salt crystals and melted to form pure water.

In operation, freeze crystallization can be achieved by direct cooling or indirect cooling. As water in brine freezes forming pure ice, salt remains in the brine solution until salt concentration reaches the saturation point (eutectic point). As more heat is removed from the solution, salt is crystallized. Typically, in existing freeze based processes ice floats on the top of the brine solution while salt crystals are collected on the bottom. After ice is collected, it is melted to produce non-saline, drinking or potable water (for example, water with less than 100 ppm salinity).

Despite its potential, the freeze crystallization process has not been successfully implemented on a large, commercial scale. Historically, there have been three principal challenges: (i) the difficulty in using refrigeration systems to efficiently freeze large quantities of saline water without forming large chunks of ice; and (ii) equipment/plant complexity. Systems that utilize indirect cooling (e.g. external refrigeration) require large vessels to hold the saline water, which results in inefficient heat transfer between the refrigerant and the saline water. Direct refrigerant injection into the saline water exhibits a higher heat transfer surface area, but requires the additional step of the recovering refrigerant from the saline water. In both methods, the complexity of handling and separating the brine/ice slurry remains an obstacle.

Because of the drawbacks of the existing desalination and freeze crystallization methods discussed above, there is a need for a highly efficient and cost effective desalination method that allows fresh drinking (i.e. potable) water to be produced. The method disclosed herein solves the obstacles of conventional freeze desalination technologies by providing an energy efficient method to form ice crystals without limitations of existing systems. The resulting ice and salt crystals can be easily separated, thus reducing the equipment complexity often required for conventional freeze crystallization processes. The method disclosed herein also allows for 100% water recovery from brine producing pure water and salts.

It therefore is an object of the present disclosure to provide a novel, cost-effective and efficient process for desalinating high salinity brine using a controlled freeze method, wherein direct contact between a cold expanding stream of compressed fluid and saline water droplets allows for the production of ice crystals (containing pure water) and salt crystals to be formed, whereby the salt ions diffuse toward a center of the droplet during the freeze process and form salt crystals. The salt and water crystals can then be readily separated. As described herein, the energy required for the saline water cooling and freezing is provided by the expanding and cooling of compressed fluid and vaporization of the fluid.

The process disclosed herein is fast, reduces energy requirements, has less complex and smaller equipment, a high fresh water production (potential of 100%), and is more cost efficient for treatment of high salinity water than other methods.

### BRIEF DESCRIPTION

These and other shortcomings of the prior art are addressed by the present disclosure, which includes a desalination system and a desalinating process.

In accordance with one embodiment, a system for desalination is provided. The system comprises a feed source of saline water, a feed source of at least one refrigerant, a compressor, a condenser, at least one expansion device, a freezing chamber and at least one injector. The compressor comprising an input fluidly coupled to the source of said at least one refrigerant and an output, and configured to generate a compressed vaporized refrigerant. The condenser comprising an input fluidly coupled to the compressor and an output. The condenser operatively configured to simultaneously melt frozen saline water droplets and generate a chilled, partially liquefied refrigerant stream. The at least one expansion device comprising at least one input fluidly coupled to the condenser and at least one output configured to release the chilled refrigerant stream at a refrigerant stream injection velocity. The freezing chamber comprising at least one input to introduce the chilled refrigerant stream into the chamber, and a first and second output. The at least one injector configured to introduce the saline water into the freezing chamber in the form of saline water droplets to freeze the saline water droplets. One or more parameters relative to the saline water droplets and the chilled refrigerant stream provide for a controlled freezing of the saline water droplets to promote salt ions in the saline water droplets to diffuse towards a center of each of the frozen saline water droplets and form salt crystals in a center of each frozen saline water droplet surrounded by ice crystals comprising pure water.

In another aspect of the present disclosure, the desalination system comprises a desalination system. The system comprises a compressor, a condenser, an expander, and a freezing chamber. The compressor, the condenser, the expander and the freezing chamber are connected in a closed system to circulate a refrigerant stream. The system further comprises an injector configured to introduce simultaneously into the freezing chamber the refrigerant stream and a saline water stream in the form of saline water droplets. One or more parameters relative to the saline water droplets and the chilled refrigerant stream provide for a controlled freezing of the saline water droplets to promote salt ions in the saline water droplets to diffuse towards a center of each of the frozen saline water droplets and form salt crystals in a center of each frozen saline water droplet surrounded by ice crystals comprising pure water.

In another aspect of the present disclosure, a desalinating process is provided. The desalinating process comprises the steps of: (a) providing at least one refrigerant and a feed source of saline water; (b) compressing the at least one refrigerant to generate a compressed vaporized refrigerant stream; (c) condensing the compressed vaporized refrigerant stream to generate a partially liquefied, chilled refrigerant stream; (d) expanding the partially liquefied, chilled refrigerant stream through an expansion device to generate a chilled refrigerant stream; (e) injecting the saline water into a freezing chamber in the form of saline water droplets; (f) freezing the saline water droplets) to form frozen saline water droplets by contacting the saline water droplets with the chilled refrigerant stream in the freezing chamber in a controlled freeze process to promote salt ions in the saline water droplets to diffuse towards a center of each of the frozen saline water droplets and form salt crystals in a center of each frozen saline water droplet surrounded by ice crystals comprising pure water; (g) removing the frozen saline water droplets from the freezing chamber and delivering to an ice melter; (i) melting the frozen saline water droplets to generate pure water and salt crystals; and (j) withdrawing pure water from the ice melter.

Various refinements of the features noted above exist in relation to the various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein: in accordance with one or more embodiments shown or described herein;

FIG. 1 is a simplified schematic of an embodiment of the desalinating system, in accordance with one or more embodiments shown or described herein;

FIG. 2 is a graphical illustration showing the salt diffusion time (sec) as a function of droplet diameter (μm), in accordance with one or more embodiments shown or described herein;

FIG. 3 is a simplified schematic side view of an embodiment of a portion of the desalinating system of FIG. 1, and more particularly an ice melter, prior to melting of the frozen saline water droplets, in accordance with one or more embodiments shown or described herein;

FIG. 4 is a simplified schematic side view of an embodiment of the portion of the desalinating system of FIG. 3, and more particularly the ice melter, after melting of the frozen saline water droplets, in accordance with one or more embodiments shown or described herein;

FIG. 5 is a simplified schematic rear view of the embodiment of the portion of the desalinating system of FIG. 3, and more particularly the ice melter, in accordance with one or more embodiments shown or described herein;

FIG. 6 is a simplified schematic cross-section view depicting an alternate embodiment of a portion of a desalinating system, and more particularly an ice melter, in accordance with one or more embodiments shown or described herein;

FIG. 7 is a simplified schematic top view depicting an alternate embodiment of a portion of a desalinating system, and more particularly an ice melter, in accordance with one or more embodiments shown or described herein;

FIG. 8 is a simplified schematic cross-section view of the embodiment of a portion of a desalinating system of FIG. 7, and more particularly the ice melter, in accordance with one or more embodiments shown or described herein; and

FIG. 9 is a flow chart illustrating the process steps, in accordance with one or more embodiments shown or described herein.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about.”

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises”, “comprising”, “includes”, “including”, “has”, “having”, or any other variation thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

As used herein, the singular forms “a”, “an”, and “the” include plural referents unless the context clearly dictates otherwise.

As used herein, the term “saline water” refers to the water that contains a significant amount of at least one kind of dissolved salt at a given temperature. It can also be referred to as, or used interchangeably with, the terms “salt water”, “sea water”, “brackish water”, or “brine”.

As used herein, the term “purified water” or “pure water” or “fresh water” means water containing no or low concentrations of dissolved salts, and more specifically water having a salinity of less than 0.05% at a given temperature.

For purposes of this application “drinking water” or “potable water” is defined as fresh water that is safe enough for drinking or food preparation.

As used herein, the term “vessel” or “tank” includes storage mediums known in the art, including but not limited to pipes, containers, chambers, reservoirs, vats, and other receptacles.

As used herein, the term micron (μ) and micrometer (μm) are interchangeable and defined as an SI derived unit of length equaling 1×10⁻⁶ of a meter.

Embodiments of the present disclosure include a desalination system using a freeze method, wherein direct contact between a cold expanding stream of compressed fluid and saline water droplets allows for the production of ice crystals (containing pure water) and salt crystals to be formed, whereby the freeze process is controlled to provide the salt ions to diffuse toward a center of the droplet and form salt crystals during the freeze process. The salt and water crystals can then be readily separated in an integrated heat exchanger.

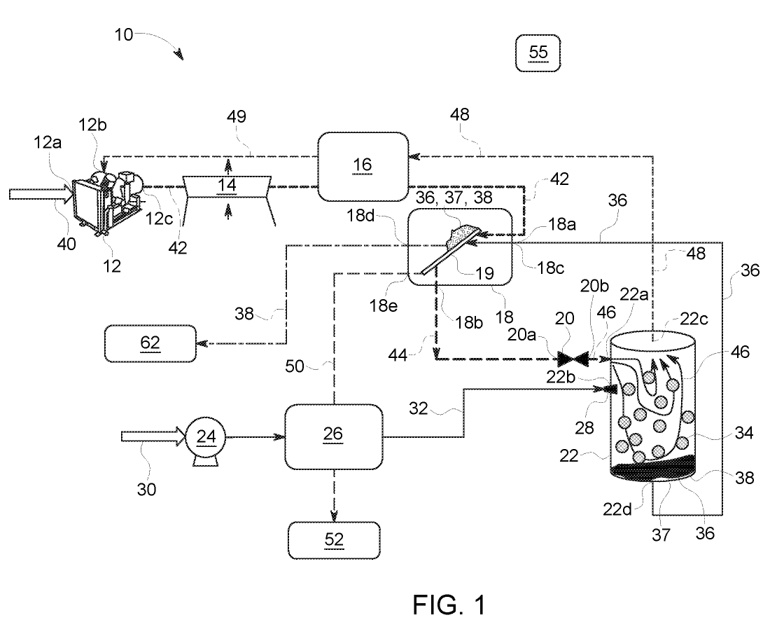

As previously indicated the current disclosure provides for a method of desalination using a freeze process and the separation thereafter of the salt crystals and melted ice crystals to provide salt and potable water. Referring now to the drawings, it is noted that like numerals refer to like elements throughout the several views and that the elements shown in the Figures are not drawn to scale and no dimensions should be inferred from relative sizes and distances illustrated in the Figures. Illustrated in FIG. 1 is a simplified diagrammatic/schematic view of an exemplary desalination system 10 having a feed source of a saline fluid, and more particularly a saline water 30, and a feed source of at least one refrigerant 40. In accordance with the present disclosure, the saline water 30 includes slightly saline water (about 1,000 to 3,000 ppm (0.1-0.3%)), moderately saline water (about 3,000 to 10,000 ppm (0.3-1%)), highly saline water (about 10,000 to 35,000 ppm or 1-3.5%), and brine. Seawater, a highly saline water, typically has a salinity of about 35,000 ppm. Brine refers to any water with an extremely high salinity of greater than 3.5% (e.g. including up to and including 15%, 20%, etc.), and brackish water refers to water with a salinity of about 0.05% to about 3%. For purposes of this disclosure, the terms “saline fluid” and “saline water” includes each of the above terms.

Referring still to FIG. 1, the desalination system 10 employs at least one compressor 12, an air cooler 14, a first heat exchanger 16, a condenser 18, an expansion device 20, and a freezing chamber 22. System 10 also includes at least one pump 24 and a second heat exchanger 26.

In an embodiment of the present disclosure, the at least one pump 24 provides for compressing of the input saline water 30 and for the introducing of the saline water 30 into the second heat exchanger 26 and an expansion device, such as an ejector or nozzle 28. In an alternate embodiment, the expansion devices 20 and 28 may comprise any type of expander known in the art. One of ordinary skill in the art will recognize that the fluids circulating through system 10 can flow through the system via known-in-the-art mass-transport forces, such as pumping, gravity, pressure, and suction.

In embodiments of the present disclosure, the at least one refrigerant 40 is capable of at least partially condensing into a liquid at temperatures slightly above 0° C. In one embodiment, the refrigerant is propane or ammonia. In still other embodiments, the refrigerant is a chlorine-bearing or fluorine-bearing carbon compounds, hydrocarbons, methyl chloride, and/or mixtures thereof. By way of example only, the hydrocarbon could be propane, iso-pentane, butane, iso-butane, pentane and mixtures thereof. Additional refrigerants would include any chlorofluorocarbon (CFC), hydrochlorofluorocarbon (HCFC), or hydrofluorocarbon (HFC) refrigerant. One of ordinary skill in the art will recognize, however, that any refrigerant that is capable of changing phase to at least partially condense at practical temperatures and pressures (i.e. mild conditions) for a large-scale system is suitable.

More specifically, a refrigerant that absorbs heat by evaporating below the freezing point of water (32° F./0° C.) while at a relatively low pressure, is attractive. On the other hand, the same refrigerant must be able to condense at temperatures not greatly higher than normal ambient temperatures and at pressures attainable by modern compressors. Furthermore, the use of air as a refrigerant is contemplated and is within the scope of this disclosure. One of ordinary skill in the art would recognize, however, that if air is used as the refrigerant the configuration of system 10 would be modified.

Referring still to FIG. 1, the compressor 12 comprises a refrigerant feed input 12a, a recirculating refrigerant input 12b and a compressed refrigerant output 12c, wherein input 12a is fluidly coupled to a feed source of the at least one refrigerant 40. The compressor 12 is configured to generate a stream of compressed vaporized refrigerant 42, wherein the compressed vaporized refrigerant 42 is compressed to a higher pressure, resulting in a higher temperature as well (e.g. superheated vapor). In the diagram shown in FIG. 1, only one compressor is shown. However, the system 10 can include multiple stages of compression that requires the use of multiple compressors in various arrangements depending on the conditions and requirements of the systems. The present disclosure contemplates that the compressor 12 will comprise any conventional means of compressing fluids. For example, in embodiments of the disclosure, the compressor 12 is a conventional gas compressor. In accordance with the disclosure, the compressor 12 can be a reciprocating, rotary screw, centrifugal, or scroll compressor. Furthermore, the compressor 12 can either be open, hermetic, or semi-hermetic.

Referring still to FIG. 1, the compressed vaporized refrigerant 42 is then passed through the air cooler 14 to cool the pressurized compressed vaporized refrigerant 42 from the compressor 12. The cooled pressurized compressed vaporized refrigerant 42 is next passed through the first heat exchanger 16 to further cool the cooled pressurized compressed vaporized refrigerant 42 so that the cooled pressurized compressed vaporized refrigerant 42 entering the condenser 18 is cold (e.g. about 0° C. or slightly higher) and a chilled, partially condensed (liquefied) refrigerant stream 44 leaving the condenser 18 and entering the freezing chamber 22 is also cold (e.g. about 0° C. or slightly higher)

As alluded to previously, the cooled pressurized compressed vaporized refrigerant 42 is next passed through the condenser 18. In the embodiment shown here, the condenser 18 is operatively configured to further cool and condense the cooled pressurized compressed vaporized refrigerant 42 into the chilled, partially condensed (liquefied) refrigerant stream 44 via indirect heat exchange. For example, condenser 18 is an ice melter 19 configured to melt ice crystals (described presently) delivered from the freezing chamber 22 (e.g. at the back-end of the process). In this way, the ice melter 19 both generates a pure water stream 50, by separating out the salt crystals 38 from the water stream 50, and also condenses the cooled pressurized compressed vaporized refrigerant 42 to generate the chilled, partially condensed (liquefied) refrigerant stream 44 via indirect heat exchange. In this embodiment, condenser 18 further comprises a cooled pressurized compressed vaporized refrigerant input 18a, a condensed refrigerant stream output 18b, a frozen saline water droplet input 18c, a salt crystal output 18d and a pure water stream output 18e. The input 18c is fluidly coupled to an output of the freezing chamber 22, the salt crystal output 18d is coupled to an optional salt crystal storage tank 62 for the storage therein of the separated salt crystals 38, and said output 18e is coupled to a pure water storage tank 52 for the storage therein of the pure water 50. While it is contemplated that system 10 can include other conventional devices or units capable of condensing the cooled pressurized compressed vaporized refrigerant 42 from its gaseous to its liquid state by cooling it, the embodiment illustrated in FIG. 1 allows system 10 to recover energy invested in the freezing of the saline water by using it to condense the refrigerant, thereby increasing process efficiency and reducing power requirements for the system.

The chilled, partially condensed (liquefied) refrigerant stream 44, which is at least partially-liquefied and in the thermodynamic state known as a saturated liquid, is next routed through the expansion device 20 where it undergoes an abrupt reduction in pressure and lowers the temperature of the liquid and vapor refrigerant mixture. In this particular embodiment, the expansion device is a Joule-Thomson (JT) valve 21, whereby the chilled, partially condensed (liquefied) refrigerant stream 44 is expanded such that liquid portion of the refrigerant 44 is evaporated due to the pressure change and further cools the chilled vapor refrigerant stream 46. One of ordinary skill in the art will recognize that any conventional expander capable of converting compressed fluids into an expanded, chilled vapor and also capable of handling multi-phase fluids (e.g. 2 or preferably, 3, phases) can be used. The expansion device 20 produces a chilled stream of refrigerant 46, which in turn lowers the temperature in the freezing chamber 22 to the desired temperature to freeze the injected saline water droplets (described presently).

Referring to FIG. 1, the expansion device 20 is fluidly coupled to the condenser 18 via an input 20a to receive the chilled, partially condensed (liquefied) refrigerant stream 44 and create the chilled stream of vapor refrigerant 46 output at an output 20b, that will provide sufficient hyper-cooling within the freezing chamber 22 for the freeze desalination process described herein.

In accordance with this disclosure, regardless of the specific device used, the expansion device 20 is capable of receiving an input in the range of about 44 pounds per square in absolute or psia (SI units=303369 Pa) to about 220 psia (SI units=1516847 Pa) and of producing an output in the range of about 14.7 psia (SI units=101353 Pa) to about 44 psia (SI units=303369 Pa). In embodiments of the present disclosure, the requisite input and output capacities for the expansion device will vary and depend on the characteristics of the fluids and other environmental factors. For example, in some embodiments the input capacity will be 44, 45, 50, 55, 65, 25, 27, 30, 35, 50, 100, 120, 150, 200 or 220 psia, including any and all values, ranges and subranges therein (e.g., 44 to 220 psia, 44 to 60 psia, 44 to 100 psia, 50 to 200 psia, 50 to 150 psia, 100 to 220 psia, 70 to 100 psia, 200 to 220 psia, etc.). In some embodiments the output capacity will be 14.7, 15, 16, 20, 23, 25, 25, 27, 30, 32, 35, 40, 43 or 44 psia, including any and all values, ranges and subranges therein (e.g., 14.7 to 44 psia, 16 to 44 psia, 25 to 44 psia, 30 to 40 psia, 14.7 to 22 psia, 14.7 to 30 psia, 20 to 30 psia, 40 to 44 psia, etc.). For purposes of the above values, one of ordinary skill in the art will recognize that the US customary unit for pressure, pounds per square inch absolute (psia) is equivalent to and can be converted to SI units using a conversion of 1 psia is equal to 6894.75728 pascal (Pa).

The freezing chamber 22 is operatively configured to provide direct contact between the chilled stream of refrigerant 46 and a cooled saline water stream 32 exiting the second heat exchanger 26. The freezing chamber 22 has an inner surface that defines a volume and the size and configuration of the chamber 22 can vary, depending on the system needs and capacities required. Further, in an embodiment the freezing chamber 22 includes a first inlet 22a from which the chilled stream of refrigerant 46 enters the freezing chamber 22, a second inlet 22b from which the compressed saline water 32 enters the freezing chamber 22, a first outlet 22c from which the refrigerant vapors exit the freezing chamber 22 as a vapor stream 48 and are recycled back to compressor 12 to form a closed loop refrigeration system and a second outlet 22d from which frozen saline water droplets 36 comprising ice crystals 37 and salt crystals 38 formed therein a center of the droplets, exit the freezing chamber 22. In an embodiment, the at least one injector 28 is configured to introduce the cooled saline water 32 into the freezing chamber 22 in the form of saline water droplets 34. When the saline water droplets 34 contact the incoming chilled stream of refrigerant 46, the refrigerant cools the droplets and the saline water droplets 34 freeze to simultaneously form the ice crystals 37 and the salt crystals 38, whereby the ice crystals 37 are allowed to freeze in a manner that provides for the salt ions to diffuse toward a center of the saline water droplets 34 during the freeze process.

More particularly, during the freeze process, the freeze time of the saline water droplets 34 may be controlled/adjusted based on the size of the input saline water droplets 34. During the droplet freeze process the freeze time may be adjusted to provide sufficient time for the salt ions in the saline water droplets 34 to diffuse towards the center of the saline water droplets 34 and form the salt crystals 38. Accordingly, larger saline water droplets 34 will require a longer freeze time within the freezing chamber 22. To provides such controlled freezing and diffusion of the salt ions to the center of the droplets 34, the freeze time may be adjusted by such process parameters as: (i) the temperature of the chilled stream of refrigerant 46; (ii) the amount of the chilled stream of refrigerant 46 relative to the amount of saline water droplets 34 injected; (iii) the injection velocity of the saline water droplets 34 relative to the flow of the chilled stream of refrigerant 46; (iv) the droplet size of the saline water droplets 34; and (v) the size of the freezing chamber 22. The size of the saline water droplets 34 may be adjusted by selection of the size of the at least one injector 28.

In further accordance with the described employing of controlled freezing and diffusion of the salt ions to the center of the droplets 34, in an embodiment of the present disclosure, the temperature of the chilled stream of refrigerant 46 in the freezing chamber is about 0° C. to about −50° C. For example, in some embodiments refrigerant stream has temperature of 0-50° C., including any and all values, ranges and subranges therein (e.g., 0 to −50° C., 0 to −48° C., 0 to −45° C., 0 to −20° C., 0 to −10° C., 0 to −5° C., 0 to −2° C., −2 to −50° C., −5 to −40° C., −2 to −30° C., −21 to −23° C., −21 to −25° C., etc.). While not meant to be limiting, in preferred embodiments, the temperature is approximately 0° C., or a little below 0° C. (e.g. −1° C., −2° C., −5° C.).

The injector 28 is preferably equipped with a nozzle configured to introduce the cooled pressurized saline water 32 into the freezing chamber 22 in the form of a spray comprising the saline water droplets 34. In further accordance with the described employing of controlled freezing and diffusion of the salt ions to the center of the droplets 34, in an embodiment of the present disclosure, the injector 28 is a sprayer comprising a nozzle operatively configured to introduce the saline water droplets 34 with an initial diameter (dᵢ) less than 1 mm in diameter, more preferably an initial diameter (dᵢ) of about 200 microns (μ) to about 1000 microns (μ), into freezing chamber 35. For example, in some embodiments, saline water droplets with an initial diameter (dᵢ) of 200, 201, 205, 210, 250, 300, 350, 400, 500, 550, 600, 700, 800, 900, 995, 999, 1000 microns, including any and all values, ranges and subranges therein (e.g., 200 to 1000 microns, 200 to 999 microns, 200 to 900 microns, 200 to 700 microns, 200 to 500 microns, 200 to 250 microns, 201 to 1000 microns, 205 to 999 microns, 500 to 1000 microns, 600 to 900 microns, etc.).

While any size and variations of injector configurations are contemplated, the configuration of injector 28 is sufficient to produce a minimum spray water droplet size in the range of less than 1 millimeter (mm). Injector 28 will also be selected in accordance with the pressure, spray angle and distribution pattern required for the particular system and conditions, and generally speaking, an injector configuration that operates at higher pressures will produce saline water droplets with a smaller initial diameter, thus providing a slower freeze time to allow for the diffusion of the salt ions to the center of the saline water droplets 34. Although not meant to be limiting, in the examples disclosed herein, the injector operates at saline water pressures in the range of about 2 bar to about 10 bars.

In operation, dependent upon certain parameters of the incoming chilled stream of refrigerant 46, the incoming cooled saline water 32 and droplet size, the system enables the saline water droplets 34 to freeze within a specific residence time (or “RT”). For purposes of this disclosure, residence time is defined as the average amount of time a particle (or, in this case, a water droplet) will spend in the freezing chamber 22 under set conditions. As is typical in the art, the residence time is calculated from the moment a particle enters the freezing chamber 22 and ends the moment it would leave the freezing chamber 22. However, one of ordinary skill in the art will recognize that it will change and can be defined as needed according to the application, the inflow and outflow rates, droplet size and the size of the desalination system (e.g. size of the turbo expander). As previously described, the residence time may be adjusted to provide for sufficient time for the salt ions in the saline water droplets 34 to diffuse toward a center of the droplets 34 and form salt crystals 38, surrounded by formed ice crystals 37.

For example, a characteristic residence time of a particle in the freezing chamber 22 is in the range of about 100 milliseconds (ms) to about 10000 milliseconds (ms) Furthermore, it is contemplated that in some embodiments, the RT will be 100, 205, 310, 450, 580, 600, 750, 880, or 10000 ms, including any and all values, ranges and subranges therein (e.g., 100 to 10000 ms, 210 to 10000 ms, 320 to 490 ms, 321 to 550 ms, 600 to 800 ms, 450 to 10000 ms, 100 to 200 ms, 100 to 150 ms, 100 to 130 ms, 100 to 410 ms, 200 to 750 ms, etc.).

In accordance with embodiments of the present disclosure, the size of the saline water droplet 34 is controlled and predetermined to ensure that proper freezing occurs during the calculated residence time (RT) in the chamber, and so as to allow for diffusion of the salt ions to the center of the droplet 34. By way of example, if a freezing chamber 22 has a residence time of about 10 milliseconds (ms), the droplet size injected into the chamber 22 should be selected to provide for direct contact between all of the saline water droplets 34 and the chilled stream of refrigerant 46, thus ensuring that the cooling of the saline water droplets 34 by direct contact with the chilled stream of refrigerant 46 will produce an efficient heat transfer between the refrigerant and the saline water and provide sufficient time for diffusion of the salt ions.

As the saline water droplets are super-cooled, or frozen, in the chamber 22, the salt ions diffuse toward the center of each saline water droplet, providing for the formation of frozen saline water droplets 36 comprising ice particles or crystals about the centralized salt particles or crystals. Referring still to FIG. 1, the second outlet 22d of the freezing chamber 22 is fluidly coupled to the condenser 18 to provide for melting of the frozen saline water droplets 36, and more particularly the ice crystals 37. To complete the refrigeration cycle chilled stream of refrigerant 46 from the expansion device 20 exits the freezing chamber 22 as the vapor stream 48 and is routed back into the compressor 12, via the first heat exchanger 16 as a warm vapor refrigerant stream 49.

As shown in FIG. 1, the salt storage tank or vessel 62 is coupled to the ice melter 19 and the pure water storage tank or vessel 52 is fluidly coupled to the ice melter 19. Storage tank can be any container, vessel, pipe or other storage medium for holding fluids, and it can include any size and various types of tanks, based on the needs of the system. In accordance with the present disclosure, the salt storage tank 62 is operably configured to receive and store salt produced by ice melter 19 and the storage tank 52 is operably configured to receive and store pure water produced by ice melter 19. Alternatively, the salt crystals 38 retrieved from ice melter 19 are disposed of by conventional means.

In embodiments of the present disclosure, the system 10 may further include a controller 55, external or internal, operable to control the desalination system, control the flow of water and refrigerant through the system, as well as to provide the proper functionality and parameters and/or setting for the system.

In an exemplary embodiment, system 10 is configured for use in a continuous manner for purifying the saline water 30. The salinity of the pure water stream 50 exiting desalination system 10 through the condenser 18 will be less than the salinity of the source saline water 30 entering the desalination system 10. In accordance with the embodiments of the present disclosure, the difference in salinity will range from about 80 to about 99%. While the system described above may be sufficient in most applications, the system may optionally include an evaporator (not shown) and/or a crystallizer (not shown), or employ other methods and/or systems known in the art, to provide 100% water recovery.

In alternate embodiments, the method and system may incorporate a device to mechanically remove the frozen saline water droplets from the freezing chamber. Further, while not illustrated, other mechanisms, such as pumps (to draw water through the system or to/from other components in the system) may be used in accordance with the skills and methods known in the art. Furthermore, the components for the desalination system may be made of suitable materials. Suitable materials may include one or more material selected from metal or plastic. Further embodiments, and alternate configurations, for the desalination system are disclosed in copending patent application bearing Ser. No. 14/983,658, filed Dec. 20, 2015, entitled “Water Desalination System and Method for Fast Cooling Saline Water using Turbines” by Lissianski et al. and assigned to the same assignee as the present disclosure and incorporated herein by reference in its entirety.

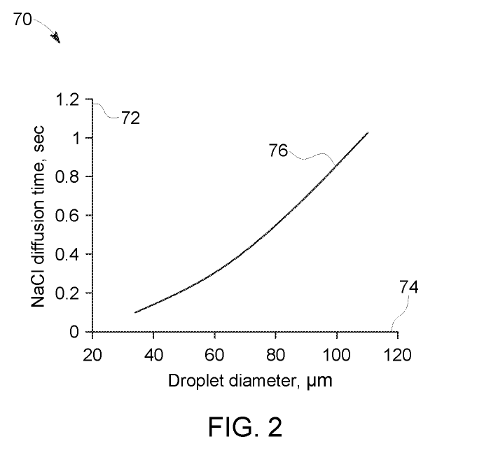

Referring to FIG. 2, shown by a graphical illustration 70 is the time (sec) required for the salt ions to diffuse to the center of the water droplets as a function of droplet diameter (μm). More particularly, the diffusion time of the salt ions toward a center of the water droplets, is measured on axis 72. The droplet diameter is measured on axis 74. As an example and as shown in FIG. 2, a saline water droplet, such as saline water droplets 34 of FIG. 1, with an initial diameters (dᵢ) of approximately 60 μm will take approximately 0.35 seconds in the freezing chamber to allow for salt ion diffusion toward the center of the saline water droplet. As illustrated by plotted line 76, as the diameter of a saline water droplet increases, the time required for salt ions to diffuse toward the center of the saline water droplet increases. Similarly, as the diameter of the saline water droplet decreases, the time required for salt ion diffusion to occur decreases.

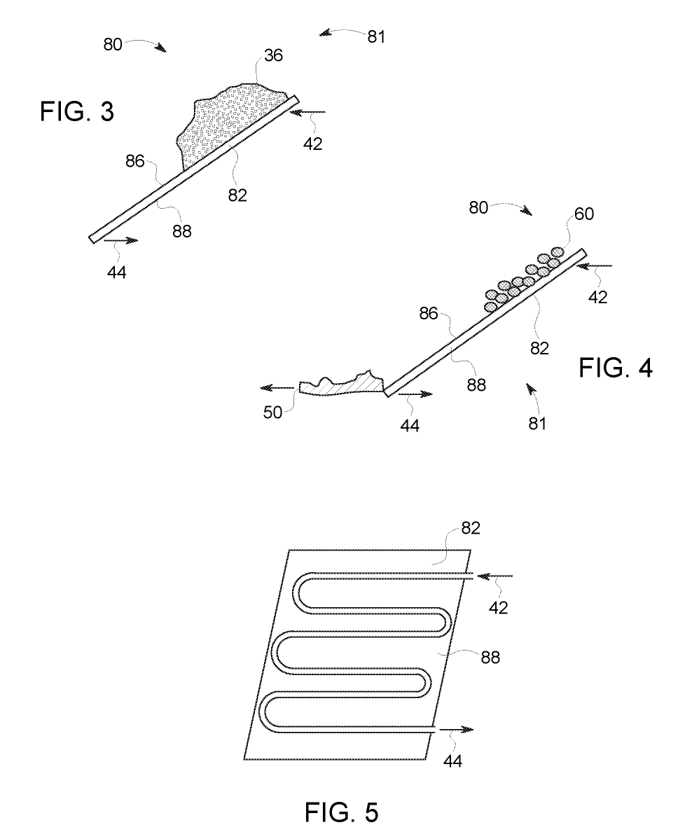

Referring now to FIGS. 3-8, illustrated are embodiments for the ice melter 19 of FIG. 1. More particularly, illustrated in FIGS. 3 and 4 is a first embodiment of the ice melter, generally referenced 80. As previously described, like numerals refer to like elements throughout the several views. The ice melter 80 both generates a pure water stream 50 and also condenses the cooled pressurized compressed vaporized refrigerant 42 to generate the chilled, partially condensed (liquefied) refrigerant stream 44 via indirect heat exchange. The ice melter 80 includes an inclined warming surface 82 onto which frozen salt water droplets 36 leaving the freezing chamber 22 are deposited. As the ice crystals 37 of the frozen salt water droplets 36 melt, the salt crystals 38 are left behind, while the pure water 50 drains from the inclined warming surface 82 toward the pure water storage tank 52 (FIG. 1). The remaining salt crystals 38 may be removed from the warming surface 82 for disposal or storage in the salt storage tank 62 (FIG. 1). As illustrated in FIGS. 3-5, the ice melter 80 is a heat exchanger 81 including a warm side 86 that is warmed by the compressed vaporized refrigerant 42 thereby providing heat for the melting of the ice crystals 37 in the frozen saline water droplets 36. The cold side 88 of the warming surface 82 provides for condensing of the input compressed vaporized refrigerant 42 to form the output chilled, partially condensed (liquefied) refrigerant stream 44.

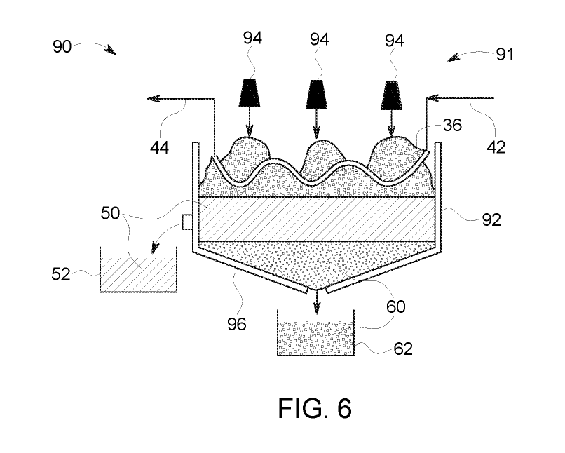

Referring now to FIG. 6, illustrated is an alternate embodiment of the ice melter 19 of FIG. 1. More particularly, illustrated in FIG. 6 is another embodiment of the ice melter, generally referenced 90. The ice melter 90 both generates a pure water stream 50 and also condenses the cooled pressurized compressed vaporized refrigerant 42 to generate the chilled, partially condensed (liquefied) refrigerant stream 44 via indirect heat exchange. The ice melter 90 is a heat exchanger 91 including a heat exchanger body 92 in fluid communication with one or more frozen saline water droplet dispensers 94. The frozen saline water droplet dispensers 94 provide for the input of the frozen saline water droplets 36, output from the freezing chamber 22 (FIG. 1), into the heat exchanger body 92. As the pressurized compressed vaporized refrigerant 42 enters the ice melter 90, it comes in contact with the frozen saline water droplets 36, thereby melting the ice crystals 37 therein and generating a pure water stream 50. As the refrigerant 42 passes therethrough the ice melter 90 it condenses to generate the output chilled, partially condensed (liquefied) refrigerant stream 44 via indirect heat exchange. As the ice crystals 37 in the frozen saline droplets 36 melt, the salt crystals 38 sink to a lower portion 96 of the ice melter 90 and are collected in the salt storage tank 62 while the pure water 50 drains from the ice melter 90 toward the pure water storage tank 52 (FIG. 1).

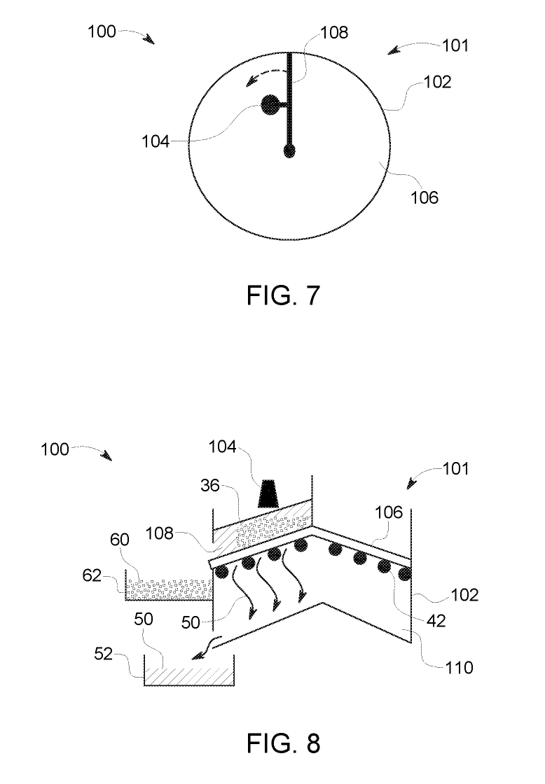

Referring now to FIGS. 7 and 8, illustrated is an alternate embodiment of the ice melter 19 of FIG. 1. More particularly, illustrated in FIGS. 7 and 8 is another embodiment of the ice melter, generally referenced 100. The ice melter 100 both generates a pure water stream 50 and also condenses the cooled pressurized compressed vaporized refrigerant 42 to generate the partially condensed (liquefied) refrigerant stream (not shown) via indirect heat exchange. The ice melter 100 is a heat exchanger 101 including a heat exchanger body 102 in fluid communication with one or more frozen saline water droplet dispensers 104, of which only one is illustrated in FIGS. 7 and 8. The frozen saline water droplet dispensers 104 provide for the input of the frozen saline water droplets 36, output from the freezing chamber 22 (FIG. 1), into the heat exchanger body 102. The heat exchanger body 102 has defined therein a perforated warming plate 106, thermally coupled to the flow therethrough of the compressed vaporized refrigerant 42 and a rotating spreader arm 108 in communication therewith the perforated warming plate 106. As the pressurized compressed vaporized refrigerant 42 flows through the ice melter 90, it comes in contact with the perforated warming plate 106 onto which the frozen saline water droplets 36 are deposited by the one or more dispensers 104. The rotating spreader arm 108 provides for dispersion of the deposited frozen saline water droplets 36 on the perforated warming plate 106 so as to allow for melting of the ice crystals 37 therein and generating of a pure water stream 50. As the refrigerant 42 passes therethrough the ice melter 100 it condenses to generate the output chilled, partially condensed (liquefied) refrigerant stream 44 via indirect heat exchange. As illustrated in FIG. 8, as the ice crystals 37 in the frozen saline droplets 36 melt, the pure water 50 drains through the perforated warming plate 106 to a lower portion 110 of the ice melter 100, leaving the salt crystals 38 on the perforated warming plate 106 for collection in the salt storage tank 62, while the pure water 50 drains from the ice melter 100 toward the pure water storage tank 52 (FIG. 1).

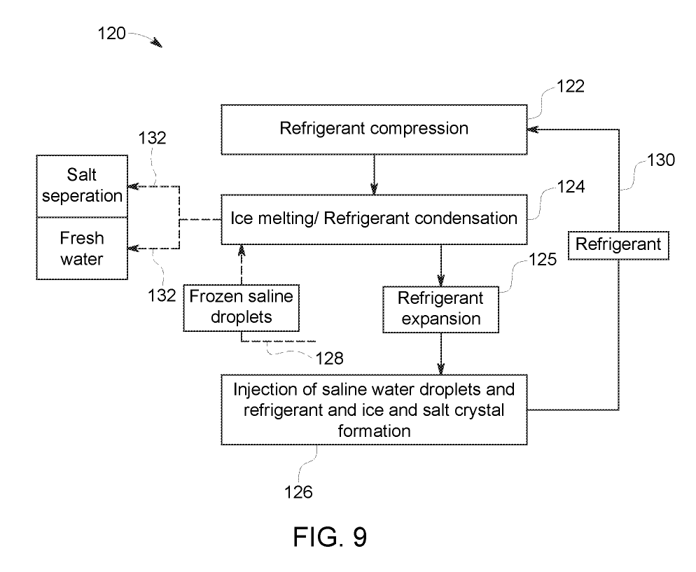

Referring now to FIG. 9, there is shown a desalinating process in accordance with a preferred embodiment of the present disclosure. More specifically, illustrated is a method 120, in which initially a refrigerant undergoes compression in a step 122 to generate a compressed vaporized refrigerant stream. The compressed vaporized refrigerant stream is input to a condenser where it provides melting to frozen saline droplets while condensing to provide a partially liquefied, chilled refrigerant stream, in a step 124. In a step 125, partially liquefied, chilled refrigerant stream is expanded in an expansion device to generate a chilled refrigerant stream. Next, in a step 126, saline water is injected into the chilled refrigerant output to provide for freezing of the saline droplets, and more particularly, controlled freezing to provide diffusion of salt ions to a center of the saline water droplet, and the formation of ice crystals about the centralized salt crystals. The frozen saline droplets are returned to the condenser for melting, in a step 128, while the refrigerant is returned to the compressor in a step 130. The melted ice crystals are output as a fresh water stream, leaving the remaining salt crystals, in a step 132.

From the above results, it will be appreciated that the use of a freeze or cooling process for desalination in which the freeze time is controlled to provide for the diffusion of the salt ions toward a center of each frozen saline droplet demonstrates an effectiveness which is both unexpected and unanticipated based on the performance of other common desalination methods, including other freeze crystallization methods. In addition, because the freeze crystallization process is operated at low temperatures, it greatly mitigates and/or avoids the scaling and membrane fouling issues that occur in other thermal and membrane processes, thereby allowing a wider selection of materials and a reduction in chemical usage to combat scaling/fouling. The process and system disclosed herein has a small footprint and low capital cost, therefore making it appropriate for a wide variety of applications, including both large scale operations and small scale operations (e.g. mobile units).

Energy requirements for the process disclosed herein are estimated to be about 45% less than that for other thermal crystallizer applications. For example, in one embodiment, 100% water recovery from 18% salinity brine using propane as a refrigerant required energy in the amount of 18 Watt-hours/liter (68 kWh/1000 gal) of brine. The process also is particularly well-suited for treatment of high salinity water and brine and embodiments of the present disclosure disclosed herein unexpectedly and effectively can treat high salinity water with reduced energy consumption (and cost).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While this disclosure has been described in conjunction with the specific embodiments described above, it is evident that many alternatives, combinations, modifications and variations are apparent to those skilled in the art. Accordingly, the preferred embodiments of this disclosure, as set forth above are intended to be illustrative only, and not in a limiting sense. Various changes can be made without departing from the spirit and scope of this disclosure. Therefore, the technical scope of the present disclosure encompasses not only those embodiments described above, but also all that fall within the scope of the appended claims.

This written description uses examples to disclose the various embodiments, including the best mode, and also to enable any person skilled in the art to practice the disclosure, including making and using any devices or systems and performing any incorporated processes. The patentable scope of the disclosure is defined by the claims, and may include other examples that occur to those skilled in the art. These other examples are intended to be within the scope of the claims if they have structural elements that do not differ from the literal language of the claims, or if they include equivalent structural elements with insubstantial differences from the literal language of the claims.

1. A system for desalination comprising:
a feed source of saline water;
a feed source of at least one refrigerant;
a compressor, comprising an input fluidly coupled to the source of said at least one refrigerant and an output, and configured to generate a compressed vaporized refrigerant;
a condenser comprising an input fluidly coupled to the compressor and a plurality of outputs, said condenser operatively configured to simultaneously melt frozen saline water droplets and generate a chilled, partially liquefied refrigerant stream;
at least one expansion device comprising at least one input fluidly coupled to the condenser and at least one output configured to release a chilled refrigerant stream at a refrigerant stream injection velocity;
a freezing chamber comprising at least one input to introduce the chilled refrigerant stream into the freezing chamber, and a first and second output; and
at least one injector configured to introduce the saline water into the freezing chamber in the form of saline water droplets to freeze the saline water droplets,
wherein one or more parameters relative to the saline water droplets and the chilled refrigerant stream provide for a controlled freezing of the saline water droplets to promote salt ions in the saline water droplets to diffuse towards a center of each of the frozen saline water droplets and form a plurality of salt crystals in a center of each frozen saline water droplet surrounded by a plurality of ice crystals comprising pure water.

2. The system of claim 1, wherein the frozen saline water droplets melt in the condenser to generate a pure water stream and an output of the plurality of salt crystals.

3. The system of claim 1, wherein the one or more parameters include a droplet size of the saline water, a temperature of the chilled refrigerant stream, an amount of the chilled refrigerant stream relative to an amount of saline water droplets injected into the freezing chamber, an injection velocity of the saline water droplets relative to the flow of the chilled refrigerant stream in the freezing chamber, and a size of the freezing chamber.

4. The system of claim 1, wherein the at least one expansion device is Joule-Thomson (JT) valve.

5. The system of claim 1, wherein the at least one injector is a sprayer comprising a nozzle operatively configured to introduce saline water droplets into the freezing chamber.

6. The system of claim 1, wherein the at least one refrigerant is selected from the group consisting of a hydrocarbon, ammonia, chlorine-containing carbon compounds, and fluorine-containing carbon compounds.

7. The system of claim 6, wherein the hydrocarbon comprises propane, isopentane, butane, iso-butane, pentane and mixtures thereof.

8. The system of claim 1, wherein the first output of the freezing chamber is connected to the condenser and the second output of the freezing chamber is fluidly coupled to the compressor to create a closed circuit for the refrigerant stream.

9. The system of claim 8, wherein:
a first input of the condenser is coupled to the compressor for input of the cooled pressurized compressed vaporized refrigerant stream;
a second input of the condenser is coupled to the freezing chamber for the input of the frozen saline water droplets;
a first output of the condenser is fluidly coupled to the freezing chamber for output of the condensed refrigerant stream;
a second output of the condenser is connected to a salt collector for collecting salt crystals; and
a third output of the condenser is connected to a water collector for collecting the pure water.

10. The system of claim 1, wherein the condenser is an ice melter fluidly coupled to the freezing chamber and operatively configured to melt the ice crystals to produce pure water containing essentially no salt and to condense the refrigerant stream by indirect heat exchange.

11. The system of claim 10, wherein the ice melter comprises a heat exchanger having an inclined warming surface on which the frozen salt water droplets leaving the freezing chamber are deposited, causing the ice crystals to melt, leaving the salt crystals on the inclined warming surface and the pure water to drain therefrom.

12. The system of claim 10, wherein the ice melter comprises a heat exchanger defining a heat exchanger body into which the frozen salt water droplets leaving the freezing chamber are deposited, and wherein the compressed vaporized refrigerant flows therethrough the frozen salt water droplets to melt the ice crystals, causing the salt crystals to sink to a lower portion of the body and the pure water to drain therefrom the body.

13. The system of claim 10, wherein the ice melter comprises a heat exchanger defining a heat exchanger body including a perforated warming plate onto which the frozen salt water droplets leaving the freezing chamber are deposited thereon, causing the ice crystals to melt, leaving the salt crystals on the perforated warming plate and the pure water to drain therethrough the perforated warming plate and therefrom the body.

14. The system of claim 13, wherein the ice melter further comprises a rotating spreader arm.

15. The system of claim 1, further comprising at least one of the following:
a pump configured to compress the saline water stream prior to introduction into the at least one injector;
a storage tank fluidly connected to the condenser that stores pure water derived from the ice crystals;
an air cooler to cool the compressed refrigerant stream;
at least one heat exchanger configured to cool the compressed refrigerant stream after it exits the air cooler;
a second heat exchanger configured to cool the saline water stream before injection into the freezing chamber; and
a controller operable to control the desalination system.

16. A desalination system comprising:
a compressor, a condenser, an expander, and a freezing chamber, the compressor, the condenser, the expander and the freezing chamber connected in a closed system to circulate a refrigerant stream; and
an injector configured to introduce simultaneously into the freezing chamber the refrigerant stream and a saline water stream in the form of saline water droplets,
wherein one or more parameters relative to the saline water droplets and the chilled refrigerant stream provide for a controlled freezing of the saline water droplets to promote salt ions in the saline water droplets to diffuse towards a center of each of the frozen saline water droplets and form salt crystals in a center of each frozen saline water droplet surrounded by ice crystals comprising pure water.

17. The system of claim 16, wherein the at least one refrigerant is selected from the group consisting of a hydrocarbon, ammonia, chlorine-containing carbon compounds, and fluorine-containing carbon compounds.

18. The system of claim 16, wherein the one or more parameters include a droplet size of the saline water, a temperature of the chilled refrigerant stream, an amount of the chilled refrigerant stream relative to an amount of saline water droplets injected into the freezing chamber, an injection velocity of the saline water droplets relative to the flow of the chilled refrigerant stream in the freezing chamber, and a size of the freezing chamber.

19. The desalination system of claim 16, wherein the condenser is an ice melter configured to melt the ice crystals and generate a partially liquefied, chilled refrigerant stream via indirect heat exchange, and the system is configured for use in a continuous manner for purifying saline water.

20. The system of claim 19, wherein the ice melter comprises a heat exchanger having an inclined warming surface on which the frozen salt water droplets leaving the freezing chamber are deposited, causing the ice crystals to melt, leaving the salt crystals on the inclined warming surface and the pure water to drain therefrom.

21. The system of claim 19, wherein the ice melter comprises a heat exchanger defining a body into which the frozen salt water droplets leaving the freezing chamber are deposited, and wherein the stream of refrigerant flows therethrough the frozen salt water droplets to melt the ice crystals, causing the salt crystals to sink to a lower portion of the body and the pure water to drain therefrom the body.

22. The system of claim 19, wherein the ice melter comprises a heat exchanger defining a body including a perforated warming plate onto which the frozen salt water droplets leaving the freezing chamber are deposited thereon, causing the ice crystals to melt, leaving the salt crystals on the perforated warming plate and the pure water to drain therethrough the perforated warming plate and therefrom the body.

23. A desalinating process, comprising the steps of:
(a) providing at least one refrigerant and a feed source of saline water;
(b) compressing the at least one refrigerant to generate a compressed vaporized refrigerant stream;
(c) condensing the compressed vaporized refrigerant stream to generate a partially liquefied, chilled refrigerant stream;
(d) expanding the partially liquefied, chilled refrigerant stream through an expansion device to generate a chilled refrigerant stream;
(e) injecting the saline water into a freezing chamber in the form of saline water droplets;
(f) freezing the saline water droplets) to form frozen saline water droplets by contacting the saline water droplets with the chilled refrigerant stream in the freezing chamber in a controlled freeze process to promote salt ions in the saline water droplets to diffuse towards a center of each of the frozen saline water droplets and form salt crystals in a center of each frozen saline water droplet surrounded by ice crystals comprising pure water;
(g) removing the frozen saline water droplets from the freezing chamber and delivering to an ice melter;
(i) melting the frozen saline water droplets to generate pure water and salt crystals; and
(j) withdrawing pure water from the ice melter.

24. The method of claim 23, wherein said refrigerant is selected from the group consisting of a hydrocarbon, ammonia, chlorine-containing carbon compounds, and fluorine-containing carbon compounds, and the ice melter is a condenser that melts the ice crystals by indirect heat exchange between the refrigerant stream and the ice crystals to produce pure water and the partially liquefied, chilled refrigerant stream of step (b).

25. The system of claim 23, wherein the ice melter comprises a heat exchanger having an inclined warming surface on which the frozen salt water droplets leaving the freezing chamber are deposited, causing the ice crystals to melt, leaving the salt on the inclined warming surface and the pure water to drain therefrom.

26. The system of claim 234, wherein the ice melter comprises a heat exchanger defining a body into which the frozen salt water droplets leaving the freezing chamber are deposited, and wherein the stream of refrigerant flows therethrough the frozen salt water droplets to melt the ice crystals causing the salt crystals to sink to a lower portion of the body and the pure water to drain therefrom the body.

27. The system of claim 23, wherein the ice melter comprises a heat exchanger defining a body including a perforated warming plate onto which the frozen salt water droplets leaving the freezing chamber are deposited thereon, causing the ice crystals to melt, leaving the salt crystals on the perforated warming plate and the pure water to drain therethrough the perforated warming plate and therefrom the body.
